(19) United States
(12) Patent Application Publication
(10) Pub. No.: US 2016/0282278 A1
(43) Pub. Date: Sep. 29, 2016

(54) CHEMICAL CLEANLINESS TEST METHOD PRIOR TO SURFACE TREATMENT

(71) Applicant: CUMMINS INC., Columbus, IN (US)

(72) Inventors: Lisa Lynn Earnest, Columbus, IN (US); Jeff L. Klopfenstein, Columbus, IN (US); Melissa R. Dahn, Columbus, IN (US); Barbara Traenkenschuh, Mainz (DE)

(21) Appl. No.: 15/078,244

(22) Filed: Mar. 23, 2016

Related U.S. Application Data
(60) Provisional application No. 62/136,765, filed on Mar. 23, 2015.

(51) Int. Cl. G01N 21/88; G01N 21/94

(52) U.S. Cl. CPC G01N 21/8803; G01N 21/94

(57) ABSTRACT

A method is provided for testing the chemical cleanliness of a part, comprising submerging a part in one of a polar and a non-polar solvent, allowing the part to dry after submersion in the one of the polar and the non-polar solvent, submerging the part in the other of the polar and non-polar solvent, allowing the part to dry after submersion in the other of the polar and the non-polar solvent, analyzing the part according to a chemical cleanliness test comprising comparing a size of a contamination area of the part to a maximum size, responding to the contamination area being smaller than the maximum size by identifying the part as acceptable, and responding to the contamination area being larger than the maximum size by identifying the part as unacceptable.

### RELATED APPLICATIONS

The present application is based on and claims priority to U.S. Provisional Patent Application Ser. No. 62/136,765, filed on Mar. 23, 2015, the entire disclosure of which is expressly incorporated herein by reference.

### TECHNICAL FIELD

The present invention relates generally to test methods and more particularly to methods for testing the chemical cleanliness of a part prior to application of a surface treatment.

### BACKGROUND

Surface treatments are applied to many metals (and other materials) during various manufacturing processes. Such treatments, including but not limited to diamond like carbon coating and plasma nitriding, may be used to improve the characteristics of the metal components (e.g., by increasing their hardness, coefficient of friction, residual stress properties, etc.), and even permit use of less expensive metals for certain applications. However, for surface treatments to adhere to or otherwise interact with the part, the surface of the part must be highly decontaminated. Any oil or other contaminants (e.g., processing fluids such as machining fluids, rust preventative fluids, etc.) remaining on the parts will degrade the performance of the surface treatment. The difficulty of removing such contaminants to the level of atomic cleanliness is exacerbated by the fact that such processing fluids are designed to adhere to the parts. Of course, if the contaminants impede the performance of the surface treatment, the part may need to be rejected, resulting in lost time and money.

A conventional approach to removing contaminants for surface treatment preparation involves trial and error washing methods. After various cleaning solutions are used, the parts are surface treated and the performance of the surface treatment is tested to determine if the cleaning solutions were effective. This approach is time consuming, repetitive and does not test the part for cleanliness prior to surface treating. Alternatively, parts may be subjected to a surface analysis such as by auger spectroscopy. This approach requires shipping the part(s) to a lab for analysis, which subjects the part(s) to other contaminants both before and after testing, and is undesirably time-consuming and expensive. Therefore, there exists a need for an improved method of testing the chemical cleanliness of parts prior to surface treatment.

### SUMMARY

According to one embodiment of the present disclosure, a method for testing the chemical cleanliness of a part prior to surface treatment of the part is provided, comprising: submerging a part in one of a polar and a non-polar solvent, allowing the part to dry after submersion in the one of the polar and the non-polar solvent, submerging the part in the other of the polar and the non-polar solvent, allowing the part to dry after submersion in the other of the polar and the non-polar solvent, analyzing the part according to a chemical cleanliness test comprising comparing a size of a contamination area of the part to a maximum size, responding to the contamination area being smaller than the maximum size by identifying the part as acceptable, and responding to the contamination area being larger than the maximum size by identifying the part as unacceptable. One aspect of this embodiment further comprises placing the part in a basket and placing the basket in a first beaker prior to submerging the part in the one of the polar and the non-polar solvent. A variant of this aspect further comprises pre-rinsing the first beaker with the one of the polar and the non-polar solvent prior to placing the basket in the first beaker. In another variant, allowing the part to dry after submersion in the one of the polar and the non-polar solvent comprises removing the basket from the first beaker and exposing the basket to room temperature for at least 5 minutes. Still another variant further comprises placing the basket in a second beaker prior to submerging the part in the other of the polar and the non-polar solvent. A modification of this variant further comprises pre-rinsing the second beaker with the other of the polar and the non-polar solvent prior to placing the basket in the second beaker. In another modification, allowing the part to dry after submersion in the other of the polar and the non-polar solvent comprises removing the basket from the second beaker and exposing the basket to room temperature for at least 15 minutes. In another aspect of this embodiment, allowing the part to dry after submersion in the one of the polar and the non-polar solvent and allowing the part to dry after submersion in the other of the polar and the non-polar solvent are performed in an area having an ambient temperature in the range of 68° F. to 77° F. In another aspect, the one of the polar and the non-polar solvent is a non-polar hydrocarbon solvent of five to seven carbon chain lengths. In yet another aspect, submerging the part in the one of the polar and the non-polar solvent comprises allowing the part to soak within the one of the polar and the non-polar solvent for at least 15 minutes. In a variant of this aspect, allowing the part to soak within the one of the polar and the non-polar solvent for at least 15 minutes comprises agitating the part. In another variant of this embodiment, the other of the polar and the non-polar solvent is an alcohol of up to three carbon chain lengths. In another variant, the maximum size is a circle having a diameter of 0.5 mm. In still another variant, the chemical cleanliness test further comprises identifying contamination areas on the part having a dimension larger than a minimum size as residual spots, considering adjacent residual spots as a single residual spot when a distance between the adjacent residual spots is less than three times the size of the largest adjacent residual spot, responding to the single residual spot being smaller than the maximum size by identifying the part as acceptable, and responding to the single residual spot being larger than the maximum size by identifying the part as unacceptable. In another variant, the chemical cleanliness test is performed using magnification of between 10× and 40×.

In another embodiment, a method of analyzing a part for chemical cleanliness prior to surface treatment of the part is provided, comprising: applying a non-polar solvent to the part and permitting the non-polar solvent to dry, applying a polar solvent to the part and permitting the polar solvent to dry, visually inspecting the part for residual spots, and identifying the part as acceptable when all of the residual spots are less than a maximum size. One aspect of this embodiment further comprises analyzing adjacent residual spots as a single residual spot when a distance between the adjacent residual spots is less than three time the size of the largest adjacent residual spot, and identifying the part as acceptable when the single residual spot is less than the maximum size. In another aspect, visually inspecting the part for residual spots comprises identifying a contamination area having a size that is greater than a minimum size as a residual spot.

In still another embodiment, a method for testing the chemical cleanliness of a part prior to surface treatment of the part is provided, comprising: submerging a part in a non-polar solvent, allowing the part to dry after submersion in the non-polar solvent, submerging the part in a polar solvent, allowing the part to dry after submersion in the polar solvent, identifying contamination areas on the part as residual spots when the contamination areas are larger than a minimum size, identifying the part as acceptable when no residual spot is larger than a maximum size and no group of adjacent residual spots is larger than the maximum size, wherein a group of adjacent residual spots is two or more residual spots spaced apart from one another by a distance that is less than three times the size of the largest residual spot of the two or more residual spots, and identifying the part as unacceptable when at least one of a residual spot and a group of adjacent residual spots is larger than the maximum size. In one aspect of this embodiment, the non-polar solvent is hexane and the polar solvent is isopropyl alcohol.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a flow diagram of a test method according to one embodiment of the present disclosure; and

FIG. 2 is a top view of a part having acceptable and unacceptable residue spots.

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION

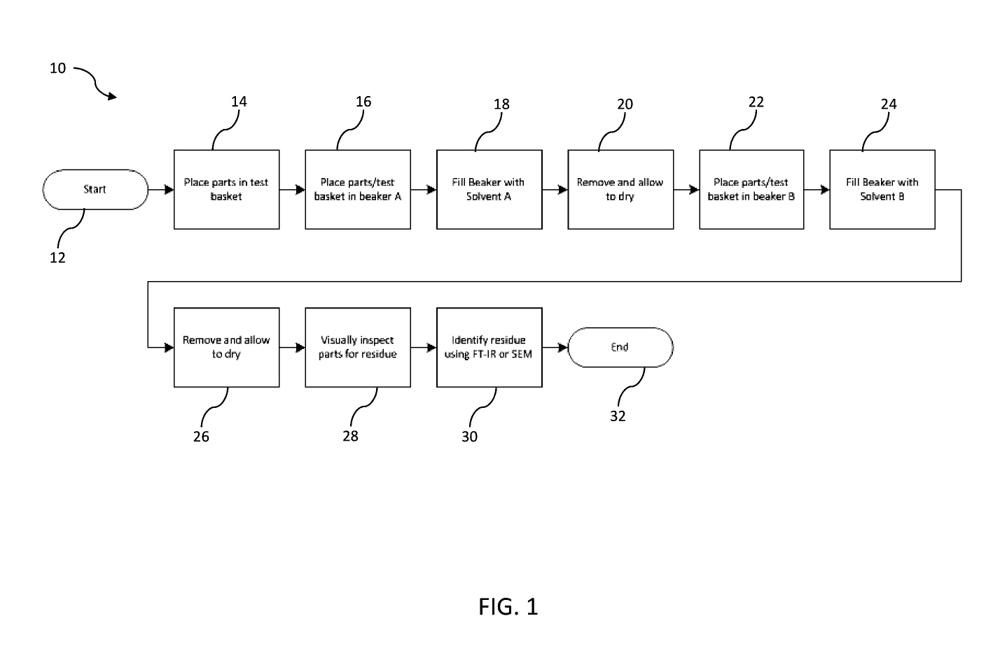

Referring now to FIG. 1, a test method 10 according to one embodiment of the present disclosure is shown. Details of the various steps of method 10 will be described in further detail below. The beginning of method 10 is represented by the start box 12. At step 14 the parts to be tested are placed in a test basket as is further described below. As explained below, in certain embodiments the placement of parts (metallic, ceramic, plastic or otherwise) does not require the use of a test basket. Then, at step 16 the basket with the parts is placed in a beaker designated beaker A. At step 18 beaker A is filled with a Solvent A as is further described below. At step 20 the basket of parts is removed from beaker A and allowed to dry in a manner described below. Then, at step 22 the basket of parts is placed in a beaker designated beaker B. At step 24 beaker B is filled with a Solvent B as is further described below. At step 26 the basket of parts is removed from beaker B and allowed to dry in a manner further described below. At step 28 the parts are visually inspected for residue in the manner described below. At step 30 the residue is optionally identified using Fourier transform infrared spectroscopy (“FT-IR”) or a scanning electron microscope. The end of method 10 is designated by end block 32.

As used herein, “surface treatments” are any hard thin film coating or other treatment that requires chemical cleanliness prior to treatment. Such coatings include, but are not limited to, those applied by Physical Vapor Deposition, Chemical Vapor Deposition, Plasma Assisted Chemical Vapor Deposition, and Plasma Enhanced Chemical Vapor Deposition. Additionally, reference herein to “inspection area(s)” means any area on a part which is not required to be handled to complete steps 28 and 30 of method 10. Similarly, “non-inspection area(s)” is/are area(s) which are required to be handled to complete steps 28 and 30. A “residue spot” as referenced herein is any white and/or “milky” and/or “cloudy” area remaining on a part after application of Solvent A and Solvent B pursuant to method 10.

Referring back to FIG. 1, method 10 should in certain embodiments be performed at or around room temperature, such as in an area having an ambient temperature within the range of 68° F. to 77° F. Method 10 may, however, be effective for certain applications when performed within a broader ambient temperature range of 0° F. to 200° F. The test baskets first referred to in step 14 may be of any of a variety of configurations that support or contain a desired number of parts for testing and permit Solvent A and Solvent B to contact the parts. In step 16, before the test basket of parts is loaded into beaker A, beaker A may be pre-rinsed with Solvent A. In step 18, Solvent A is poured over the parts (within the test basket) until the parts are fully submerged. In one embodiment of the present disclosure, Solvent A is a non-polar hydrocarbon solvent of five to seven carbon chain lengths (e.g., hexane) which is fluid filtered through a 1.0 micrometer or finer filter and stored in a clean enclosed container prior to use. Hexane removes oils but leaves behind contaminants. In certain embodiments, solvent A is either certified by the American Chemical Society (“ACS”) or reagent grade. It should be understood, however, that other non-polar solvents may also be used such as butane, pentane, heptane, octane, etc. Also, the parts in step 18 are allowed to soak within Solvent A for at least 15 minutes in one embodiment, without agitation. It should be understood, however, that in certain embodiments, a soak time of less than or greater than 15 minutes (e.g., 1 minute to 60 minutes) may be used, with or without agitation.

In step 20, the test basket of parts is permitted to dry at room temperature for at least 5 minutes. In one embodiment, no fan or other air circulation device is used, and the parts remain in the test basket. It should be understood, however, that in certain embodiments of the present disclosure, a dry time of less than or greater than 5 minutes (e.g., 1 minute to 120 minutes) may be used, and the parts may not be contained in a test basket. In other embodiments, an air circulation device may be used. In step 22, before the test basket of parts is loaded into beaker B, beaker B is pre-rinsed with Solvent B. In step 24, Solvent B is poured over the parts (within the test basket) until the parts are fully submerged. In one embodiment of the present disclosure, Solvent B is an alcohol of up to three carbon chain lengths (i.e., isopropyl alcohol) fluid filtered through a 1.0 micrometer or finer filter and stored in a clean enclosed container prior to use. Isopropyl alcohol removes water but leaves behind contaminants. In certain embodiments, solvent B is either certified by the ACS or reagent grade. It should be understood, however, that other polar solvents may also be used such as methanol, ethanol, propanol, etc. Also, the parts in step 24 are allowed to soak within Solvent B for at least 15 minutes in one embodiment, without agitation. It should be understood, however, that in certain embodiments, a soak time of less than or greater than 15 minutes (e.g., 1 minute to 120 minutes) may be used.

In step 26, the test basket of parts is permitted to dry at room temperature for at least 15 minutes. In one embodiment, no fan or other air circulation device is used, and the parts remain in the test basket. It should be understood, however, that in certain embodiments of the present disclosure, a dry time of less than or greater than 15 minutes (e.g., 1 minute to 120 minutes) may be used, and the parts do not need to be contained with a test basket. In other embodiments, an air circulation device may be used.

In step 28, the parts are first removed from the test basket in a manner that minimizes handling of the parts to reduce the number of non-inspection areas. Next, the inspection areas of the parts are visually inspected for residue spots according to the chemical cleanliness requirements established for the application. In one embodiment of the disclosure, a part fails the chemical cleanliness requirements if it includes a residue spot that is greater than 0.5 mm. Stated another way, if the part contains only residue spots that can be encompassed by a circle having a diameter of 0.5 mm, the part passes the test, except as described below. In certain embodiments, a larger or smaller diameter may be used to identify failed parts.

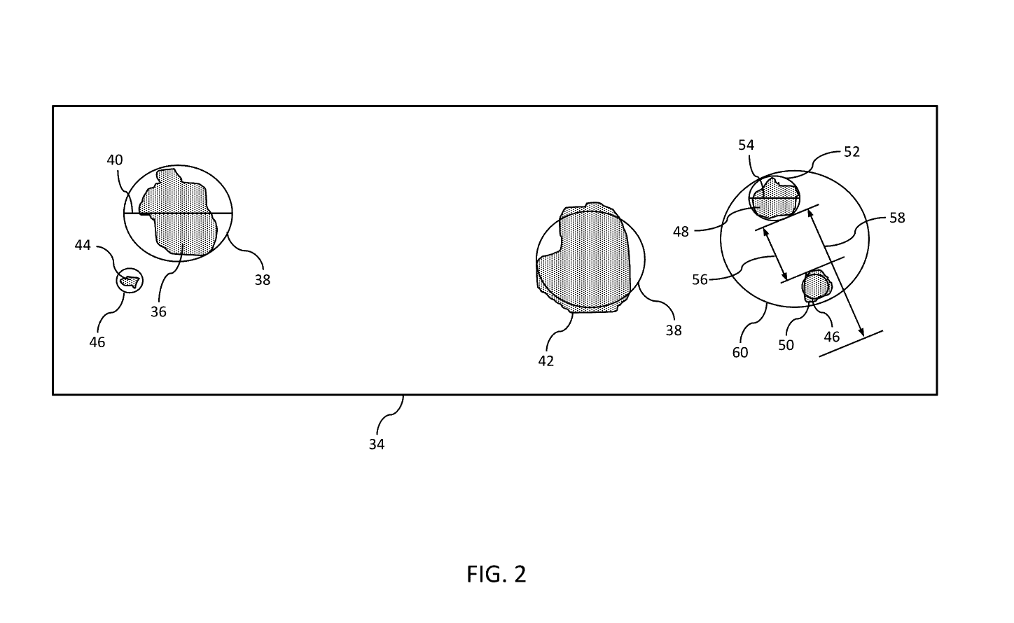

Referring now to FIG. 2, examples of acceptable and unacceptable residue spots are shown on part 34 using the example of 0.5 mm as the criteria. Residue spot 36 is acceptable (but just barely) because it fits entirely within circle 38 which has a diameter 40 of 0.5 mm. Residue spot 42, on the other hand, is unacceptable because it does not fit within circle 38. In this embodiment of the disclosure, if the distance between adjacent residue spots is less than three times the size of the largest adjacent spot, then the spots are treated as a single residue spot whose size is the diameter of a circle that can encompass all of the spots. Contamination areas that may be encompassed by a circle with a diameter of 0.1 mm are not considered residue spots and are ignored in the above-described analysis of adjacent residue spots. As shown in FIG. 2, contamination area 44 is an example of a contamination area that can fit within a circle 46 having a 0.1 mm diameter or less. Accordingly, even though area 44 is within a distance from residue spot 36 that is less than three times the size of residue spot 36 (which is of acceptable size), area 44 is not combined with residue spot 36 to make a combined spot of unacceptable size.

A combination of adjacent spots is depicted on the right-hand side of FIG. 2. As shown, residue spot 48 is adjacent residue spot 50. Spot 48 is of acceptable size because it fits within circle 52 which has a diameter 54 that is less than 0.5 mm (but greater than 0.1 mm, so spot 48 is considered a residue spot). Spot 50 is also of acceptable size but is considered a residue spot because it is larger than 0.1 mm circle 46. However, spot 50 is only a distance 56 from spot 48, which is less than distance 58 corresponding to three times the size of spot 48 (the larger of the two spots). Accordingly, the two spots 48, 50 are treated as a single, combined spot of unacceptable size because the circle 60 that encompasses the two spots is greater than 0.5 mm in diameter. It should be understood that other criteria may be used in the visual inspection of step 28 of method 10.

In one embodiment of the disclosure, the visual inspection of step 28 is carried out using a minimum of 10× magnification and a maximum of 40× magnification. In cases of dispute, inspection at 10× magnification should control. In one embodiment, the parts are inspected against a black background with light directed at the surface of the part under inspection at an angle of greater than 20 degrees from the inspector's view of the part.

In step 30 of FIG. 1, the parts may be further inspected using FR-IR and/or SEM, particularly when the parts fail the visual inspection, to determine the cause of the residue spots. It should be understood that while various steps are described with reference to method 10 of FIG. 1, several of the steps may be considered optional depending upon the application. For example, in some applications parts may be tested for chemical cleanliness by placing the parts on a conveyor belt or other moving device and moving them from station to station. In such an application, while the parts would be submerged in Solvent A and Solvent B, and dried after each submersion, the parts are not placed in or removed from test baskets, and beakers are not used. Other variations will be understood by those skilled in the art. It should be further understood that the parts may be submerged in Solvent A or Solvent B alone, or in a reverse order as that described above.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method for testing the chemical cleanliness of a part prior to surface treatment of the part, comprising:
submerging a part in one of a polar and a non-polar solvent;
allowing the part to dry after submersion in the one of the polar and the non-polar solvent;
submerging the part in the other of the polar and the non-polar solvent;
allowing the part to dry after submersion in the other of the polar and the non-polar solvent;
analyzing the part according to a chemical cleanliness test comprising
comparing a size of a contamination area of the part to a maximum size;
responding to the contamination area being smaller than the maximum size by identifying the part as acceptable; and
responding to the contamination area being larger than the maximum size by identifying the part as unacceptable.

2. The method of claim 1, further comprising:
placing the part in a basket and placing the basket in a first beaker prior to submerging the part in the one of the polar and the non-polar solvent.

3. The method of claim 2, further comprising:
pre-rinsing the first beaker with the one of the polar and the non-polar solvent prior to placing the basket in the first beaker.

4. The method of claim 2, wherein allowing the part to dry after submersion in the one of the polar and the non-polar solvent comprises removing the basket from the first beaker and exposing the basket to room temperature for at least 5 minutes.

5. The method of claim 2, further comprising:
placing the basket in a second beaker prior to submerging the part in the other of the polar and the non-polar solvent.

6. The method of claim 5, further comprising:
pre-rinsing the second beaker with the other of the polar and the non-polar solvent prior to placing the basket in the second beaker.

7. The method of claim 5, wherein allowing the part to dry after submersion in the other of the polar and the non-polar solvent comprises removing the basket from the second beaker and exposing the basket to room temperature for at least 15 minutes.

8. The method of claim 1, wherein allowing the part to dry after submersion in the one of the polar and the non-polar solvent and allowing the part to dry after submersion in the other of the polar and the non-polar solvent are performed in an area having an ambient temperature in the range of 68° F. to 77° F.

9. The method of claim 1, wherein the one of the polar and the non-polar solvent is a non-polar hydrocarbon solvent of five to seven carbon chain lengths.

10. The method of claim 1, wherein submerging the part in the one of the polar and the non-polar solvent comprises allowing the part to soak within the one of the polar and the non-polar solvent for at least 15 minutes.

11. The method of claim 10, wherein allowing the part to soak within the one of the polar and the non-polar solvent for at least 15 minutes comprises agitating the part.

12. The method of claim 1, wherein the other of the polar and the non-polar solvent is an alcohol of up to three carbon chain lengths.

13. The method of claim 1, wherein the maximum size is a circle having a diameter of 0.5 mm.

14. The method of claim 1, wherein the chemical cleanliness test further comprises:
identifying contamination areas on the part having a dimension larger than a minimum size as residual spots;
considering adjacent residual spots as a single residual spot when a distance between the adjacent residual spots is less than three times the size of the largest adjacent residual spot;
responding to the single residual spot being smaller than the maximum size by identifying the part as acceptable; and
responding to the single residual spot being larger than the maximum size by identifying the part as unacceptable.

15. The method of claim 1, wherein the chemical cleanliness test is performed using magnification of between 10× and 40×.

16. A method of analyzing a part for chemical cleanliness prior to surface treatment of the part, comprising:
applying a non-polar solvent to the part and permitting the non-polar solvent to dry;
applying a polar solvent to the part and permitting the polar solvent to dry;
visually inspecting the part for residual spots; and
identifying the part as acceptable when all of the residual spots are less than a maximum size.

17. The method of claim 16, further comprising:
analyzing adjacent residual spots as a single residual spot when a distance between the adjacent residual spots is less than three time the size of the largest adjacent residual spot; and
identifying the part as acceptable when the single residual spot is less than the maximum size.

18. The method of claim 16, wherein visually inspecting the part for residual spots comprises identifying a contamination area having a size that is greater than a minimum size as a residual spot.

19. A method for testing the chemical cleanliness of a part prior to surface treatment of the part, comprising:
submerging a part in a non-polar solvent;
allowing the part to dry after submersion in the non-polar solvent;
submerging the part in a polar solvent;
allowing the part to dry after submersion in the polar solvent;
identifying contamination areas on the part as residual spots when the contamination areas are larger than a minimum size;
identifying the part as acceptable when no residual spot is larger than a maximum size and no group of adjacent residual spots is larger than the maximum size, wherein a group of adjacent residual spots is two or more residual spots spaced apart from one another by a distance that is less than three times the size of the largest residual spot of the two or more residual spots; and
identifying the part as unacceptable when at least one of a residual spot and a group of adjacent residual spots is larger than the maximum size.

20. The method of claim 19 wherein the non-polar solvent is hexane and the polar solvent is isopropyl alcohol.
